(19) United States
(12) Patent Application Publication
(10) Pub. No.: US 2013/0097366 A1
(43) Pub. Date: Apr. 18, 2013

(54) STORAGE DEVICE AND USER DEVICE USING THE SAME

(71) Applicant: Hojun SHIM, Yongin-si (KR)

(72) Inventor: Hojun SHIM, Yongin-si (KR)

(73) Assignee: SAMSUNG ELECTRONICS CO., LTD., Suwon-si (KR)

(21) Appl. No.: 13/615,470

(22) Filed: Sep. 13, 2012

(30) Foreign Application Priority Data
Oct. 14, 2011 (KR) 10-2011-0105290

(51) Int. Cl. G06F 12/00

(52) U.S. Cl. 711/103; 711/E12.001

(57) ABSTRACT

Provided are a storage device and a user device used by connecting to the user device. The storage device may include a nonvolatile memory and a control unit configured to control the nonvolatile memory. When write data is received from the host, the control unit outputs a first response signal including information indicating whether the write data is successfully received. When the write data is stored in the nonvolatile memory, the control unit outputs a second response signal including on whether the write data is successfully stored in the nonvolatile memory. Since the storage device does not require a program backup memory, it may be implemented in a small area.

### CROSS-REFERENCE TO RELATED APPLICATIONS

This U.S. non-provisional patent application claims priority under 35 USC §119 to Korean Patent Application No. 10-2011-0105290, filed on Oct. 14, 2011, the entirety of which is hereby incorporated by reference.

### BACKGROUND OF THE INVENTION

The exemplary embodiments described herein generally relate to storage devices and user devices using the same and, more particularly, a nonvolatile memory device and a user device used by connecting to the nonvolatile memory device.

In general, semiconductor memory devices may be classified into volatile memories such as DRAM and SRAM and nonvolatile memories such as EEPROM, FRAM, PRAM, MRAM, and flash memory. Volatile memories lose their stored data when their power supplies are interrupted, while nonvolatile memories retain their stored data even when their power supplies are interrupted.

In recent years, devices using a nonvolatile memory are increasing. For example, MP3 players, digital cameras, mobile phones, camcorders, flash cards, and solid-state disks (SSDs) use a nonvolatile memory as a storage device. Among the nonvolatile memories, flash memories have a function of electrically erasing cell data collectively. Accordingly, instead of hard disks, flash storage devices including a flash memory have been widely used as storage devices.

There is an ever-increasing demand for miniaturization of user devices such as MP3 players, digital cameras, and mobile phones. With the recent trend toward miniaturization of user devices, there is also an increasing demand for miniaturization of flash memory devices used by connecting to the user devices.

### SUMMARY OF THE INVENTION

According to an aspect of an exemplary embodiment, there is provided a storage device. The storage device may include a nonvolatile memory; and a control unit configured to control the nonvolatile memory. The control unit may output a first response signal including information indicating whether the write data is successfully received from a host. The control unit may output a second response signal including information indicating whether the write data is successfully stored in the nonvolatile memory.

According to an exemplary embodiment, the first response signal and the second response signal may be output in response to one write command from the host, and the control unit may sequentially output the first response signal and the second response signal.

According to an exemplary embodiment, the storage device may further include a buffer memory which temporarily stores the write data received from the host. The control unit may output the first response signal in response to completion of the buffer memory receiving the write data.

According to an exemplary embodiment, the storage device may further include a buffer memory which temporarily stores the write data received from the host; and a page buffer which receives the write data from the buffer memory and temporarily store the write data before the write data is stored in the nonvolatile memory. The control unit may output the first response signal in response to completion of the page buffer receiving the write data.

According to an exemplary embodiment, the control unit may receive a first write command and first write data from the host before receiving a second write command and second write data from the host. The control unit may output a third response signal including information indicating whether the second write data is successfully received. The control unit may simultaneously output the third response signal and the second response signal.

According to an exemplary embodiment, the control unit may receive the second write command and the second write data from the host before receiving a dummy write command from the host The control unit may output a dummy response signal including information indicating whether the second write data is successfully stored in the nonvolatile memory. The control unit may simultaneously transfer the dummy response signal and the third response signal to the host.

According to an exemplary embodiment, the control unit may not include a volatile memory for backing up the write data.

According to another aspect of exemplary embodiments, there is provided a user device including a processing unit; and a host memory which temporarily stores write data. The processing unit may determine whether the processing unit re-transfers the write data in response to a first response signal from the storage device. The processing unit may determine whether the processing unit erases the write data stored in the host memory or re-transmits the write data in response to a second response signal from the storage device.

According to an exemplary embodiment, the first response signal may include information indicating whether the write data was successfully transferred to the storage device.

According to an exemplary embodiment, The processing unit may re-transfer the write data stored in the host memory to the storage device in response to the first response signal indicating the write data was not successfully transferred to the storage device.

According to an exemplary embodiment, the processing unit may maintain the write data stored in the host memory in response to the first response signal indicating the first data was successfully transferred to the storage device.

According to an exemplary embodiment, the second response signal may include information indicating whether the write data was successfully stored in the storage device.

According to an exemplary embodiment, the processing unit may re-transfer the write data stored in the host memory into the storage device in response to the second response signal indicating that the write data was not successfully stored.

According to an example embodiment, the processing unit may erase the write data stored in the host memory in response to the second response signal indicating that the write data was successfully stored.

According to an example embodiment, the processing unit may output first write data and second write data to the storage device and simultaneously receive the second response signal a third response signal The third response signal includes information indicating whether the second write data was successfully transferred to the storage device.

According to another aspect of exemplary embodiments, there is provided a storage device, including a nonvolatile memory and a control unit configured to output a first response signal in response to first write data received from a host and output a second response signal in response to the first write data being stored in the nonvolatile memory.

The first response signal may include information indicating whether the first write data is successfully received from the host.

The second response signal may include information indicating whether the first write data is successfully stored in the nonvolatile memory.

The second response signal may further include information indicating whether a second write data is successfully received from the host.

The storage device may further include a buffer memory which temporarily stores the first write data received from the host and a page buffer which receives the first write data from the buffer memory and temporarily stores the first write data before the first write data is stored in the nonvolatile memory. The control unit may output the first response signal in response to completion of the page buffer receiving the first write data.

### BRIEF DESCRIPTION OF THE DRAWINGS

The disclosure will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the disclosure.

FIG. 1 is a block diagram of a flash memory system according to an exemplary embodiment.

FIG. 2 exemplarily illustrates the operation of the flash memory system in FIG. 1 when there is a write request from a host.

FIG. 3 is a block diagram of a flash memory system according to another exemplary embodiment.

FIGS. 4 to 6 illustrate an exemplary embodiment of the operation of the flash memory system in FIG. 3 when there is write request from a host.

FIG. 7 is a flowchart illustrating an exemplary embodiment of the operation of a flash memory device in the flash memory system in FIG. 3.

FIG. 8 is a flowchart illustrating an exemplary embodiment of the operation of a host in the flash memory system in FIG. 3.

FIGS. 9 and 10 illustrate an exemplary embodiment of the operation of the flash memory system when there are a plurality of write commands.

FIG. 11 is a block diagram of a flash memory system according to an exemplary embodiment.

FIG. 12 is a block diagram of a flash memory system according to an exemplary embodiment.

FIG. 13 is a block diagram of a memory system according to an exemplary embodiment.

FIG. 14 illustrates a memory card according to an exemplary embodiment.

FIG. 15 illustrates a solid-state drive (SSD) according to an exemplary embodiment.

FIG. 16 is a block diagram illustrating an exemplary embodiment of a configuration of an SSD controller shown in FIG. 15.

FIG. 17 is a block diagram illustrating an example of a flash memory module implemented with a host according to an exemplary embodiment.

### DETAILED DESCRIPTION OF EXEMPLARY EMBODIMENTS

The disclosure will now be described more fully hereinafter with reference to the accompanying drawings, in which exemplary embodiments are shown. However, the disclosure may be embodied in many different forms and should not be construed as limited to the exemplary embodiments set forth herein. Rather, these exemplary embodiments are provided so that this disclosure will be thorough, and will convey the scope of the disclosure to those skilled in the art.

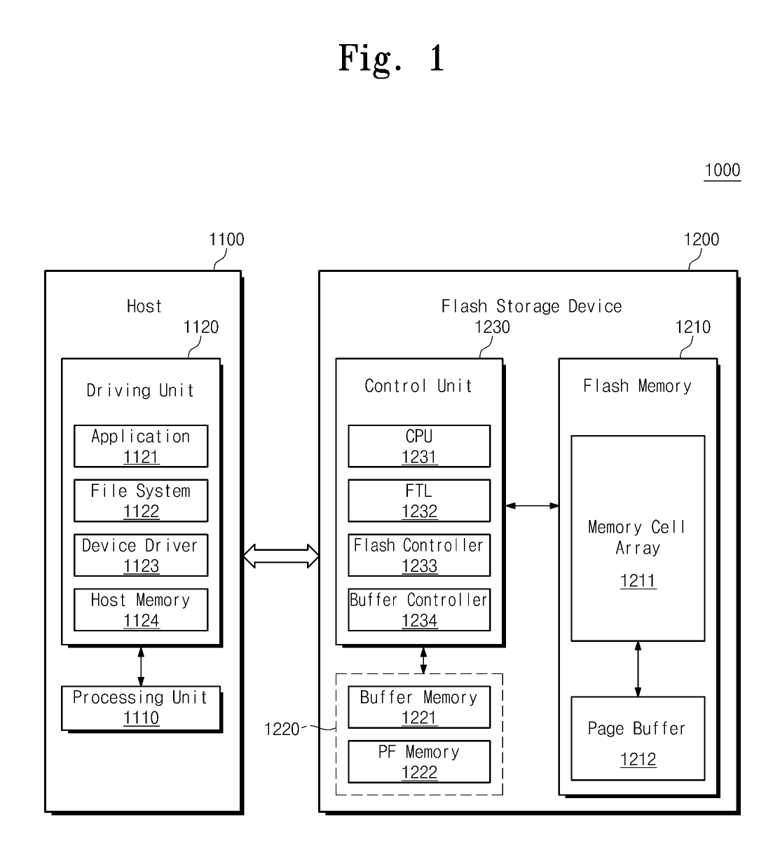

FIG. 1 is a block diagram of a flash memory system 1000 according to an exemplary embodiment. The flash memory system 1000 includes a program fail memory 1222. When an error occurs during a program operation, the flash memory system 1000 re-performs the program operation using data stored in the program fail memory 1222. Referring to FIG. 1, the flash memory system 1000 includes a host 1100 and a flash storage device 1200.

A host 1100 includes a program unit 1110 and a driving unit 1120. The host 1100 may be implemented as, for example, an MP3 player, a digital camera, a mobile phone, a portable computer, a tablet PC, etc. and may be referred to as a user device.

The processing unit 1110 controls the overall operation of the host 1100. The processing unit 1100 may be implemented as, for example, a central processing unit (CPU). The driving unit 1120 drives the flash storage device 1200 according to the control of the processing unit 1110. The driving unit 1120 may include a main memory for driving software programs of the host 1100.

The driving unit 1120 includes an application 1121, a file system 1122, a device driver 1123, and a host memory 1124.

The application 1121 is referred to as an application program and is software executed on an operating system (OS). For example, the application 1121 is programmed to support file creation and deletion operations.

The file system 1122 manages files for use in the host 1100. The file system 1122 manages, for example, files for use in the host 1100 in unit of sectors when viewed from a hard disk drive.

The device driver 1123 is a program allowing the flash memory device 1200 to communicate with the host 1100. A device driver 1123 suitable for the flash storage device 1200 is mounted at the host 1100 to use the flash storage device 1200.

The host memory 1124 temporarily stores data written in the flash storage device 1200 or data read from the flash storage device 1200. In addition, the host memory 1124 may be used as a working memory for driving the application 1121, the file system 1122, and the device driver 1123.

Continuing to refer to FIG. 1, the flash storage device 1200 includes a flash memory 1210, a working memory 1220, and a control unit 1230.

The flash memory 1210 performs an erase operation, a read operation or a program operation according to the control of the control unit 1230. The flash memory 1210 includes a memory cell array 1211 and a page buffer 1212.

The memory cell array 1211 includes a plurality of memory cells storing data therein. One bit of data or two or more bits of data may be stored in a single memory cell of the memory cell array 1211. A memory cell capable of storing one bit of data in a single memory cell is referred to as a single-level cell (SLC) or a single-bit cell, while a memory cell capable of storing at least two bits of data in a single memory cell is referred to as a multi-level cell (MLC) or a multi-bit cell. The memory cell array 1211 may include a plurality of memory blocks each including a plurality of pages.

The page buffer 1212 temporarily stores data to be programmed into the memory cell array 1211 or data read from the memory cell array 1211. For example, when a program operation is performed, the page buffer 1212 receives data to be programmed from a buffer memory 1221. Data stored in the page buffer 1212 is programmed into the memory cell array 1211 according to the control of the control unit 1230.

The working memory 1220 includes the buffer memory 1221 and the program fail memory 1222. The working memory 1220 may be implemented as a nonvolatile memory such as a DRAM or an SRAM.

The buffer memory 1221 temporarily stores data read from the flash memory 1210 or data received from the host 1100. For example, when a program operation is performed, the buffer memory 1221 receives write-requested data from the host 1100 and temporarily stores the received data. The data stored in the buffer memory 1221 is transferred to the page buffer 1212 and the program fail memory 1222 according to the control of the control unit 1230.

To protect against a program failure of the flash memory 1210, the program fail memory 1222 temporarily stores data to be programmed. Accordingly, the program fail memory 1222 may be referred to as a program backup memory.

More specifically, when there is a write request from the host 1100, write-requested data is temporarily stored in the buffer memory 1221. The data stored in the buffer memory 1221 is transferred to the program fail memory 1222 and the page buffer 1212. Therefore, the data stored in the program fail memory 1222 is identical to the data stored in the page buffer 1212. Accordingly, when an error occurs while the data stored in the page buffer 1212 is programmed into the memory cell array 1211, the flash memory 1210 may re-perform the program operation using the data stored in the program fail memory 1222.

Continuing to refer to FIG. 1, the control unit 1230 includes a central processing unit (CPU) 1231, a flash translation layer (FTL) 1232, a flash controller 1233, and a buffer controller 1234.

The CPU 1231 analyzes and processes a signal input from the host 1100. In addition, the CPU 1231 controls the overall operation of the flash storage device 1200. The FTL 1232 translates a logical address (LA) provided from the host 1100 into a physical address (PA) on the flash memory 1210. That is, the FTL 1232 functions as middleware such that the flash storage device 1200 is identically used as a hard disk drive when viewed from the host 1100. The flash controller 1233 controls read, write, and erase operations of the flash memory 1210, and the buffer controller 1234 controls read, write, and erase operations of the working memory 1221.

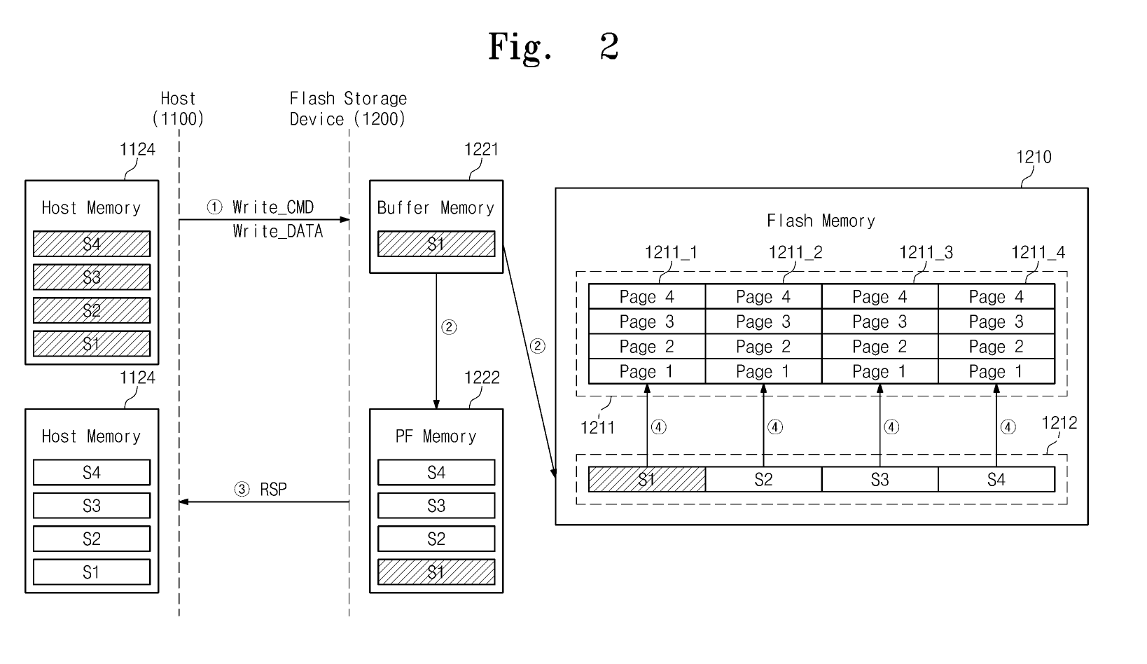

FIG. 2 illustrates an exemplary embodiment of the operation of the flash memory system 1000 in FIG. 1 when there is a write request from the host 1100.

FIG. 2 illustrates an exemplary embodiment wherein a sector unit which is a file management unit for the host 1100 matches a page unit which is a data management unit for the flash storage device 1200. In addition, the buffer memory 1221 has a size to store only data equivalent to a single page (or a single sector). Finally, the page buffer 1212 has a size to store data equivalent to four pages and the four pages are programmed at one time. As one of ordinary skill in the art will recognize, however, the sector unit, page unit, buffer memory and page buffer may vary.

Hereinafter, there will be described a case where, for example, data stored in first to fourth sectors S1-S4 of the host memory 1124 are programmed into the flash memory 1210. For the brevity of description, a sector or page storing data will be shown with oblique lines hereinafter.

Referring to FIG. 2, data are stored in the first to fourth sectors S1-S4 of the host memory 1124. The host 1100 transfers a write command Write_CMD and write data Write_DATA to the storage device 1200 to store the data stored in the first to fourth sectors S1-S4. The write data Write_DATA means data stored in the first to fourth sectors S1-S4 of the host memory 1124. The data stored in the first to fourth sectors S1-S4 are sequentially transferred to the flash storage device 1200.

The flash storage device 1200 performs an operation to program the write data Write_DATA in response to the write command Write_CMD of the host 1100.

More specifically, the buffer memory 1221 receives the write data Write_DATA from the host 1100. Since the buffer memory 1221 has a size to temporarily store only data equivalent to one sector, the buffer memory 1221 receives the data of the first sector S1 of the host memory 1124 and temporarily stores the received data of the first sector S1. Afterward, as shown in FIG. 2, the data stored in the buffer memory 1221 is transferred to the page buffer 1212 and the program fail memory 1222. Accordingly, the data of the first sector S1 of the host memory 1124 is stored in both the page buffer 1212 and the program fail memory 1222. And then, the data stored in the buffer memory 1221 is erased in response to the control of the buffer controller 1234, and the buffer memory 1221 enters a free state.

In the same manner, the buffer memory 1221 receives data of the second to fourth sectors S2-S4 of the host memory 1124, and the data of the second to fourth sectors S2-S4 of the host 1124 are stored in the page buffer 1212 and the program fail memory 1222, respectively.

When the write data Write_DATA is transferred to the flash storage device 1200 from the host 1100, the flash storage device 1200 transfers a response signal RSP to the host 1100, as shown in FIG. 2. The host 1124 erases the data of the first to fourth sectors S1-S4 stored in the host 1124 in response to the response signal RSP.

If an error occurs while the write data Write_DATA is transferred to the host 1100 from the flash storage device 1200, the response signal RSP including information on a transfer error is transferred to the host 1100. The host 1100 retransfers the data of the first to fourth sectors S1-S4 stored in the host memory 1124 to the flash storage device 1200 in response to the response signal RSP.

The data stored in the page buffer 1212 is programmed into the memory cell array 1211. FIG. 2 illustrates an exemplary embodiment wherein the memory cell array 1211 includes first to fourth memory blocks 1211_1-1211_4 each including four pages. In this case, for example, the data of the first to fourth sectors S1-S4 stored in the page buffer 1212 are programmed at one time into first pages of the first to fourth memory blocks 1211_1-1211_4, as shown in FIG. 2.

If an error occurs while the data stored in the page buffer 1212 is programmed into the memory cell array 1211, the flash storage device 1200 re-performs a program operation using the data stored in the program fail memory 1222. That is, the data of the first to fourth sectors S1-S4 stored in the program fail memory 1222 are transferred to the page buffer 1212, and the data stored in the page buffer 1212 is reprogrammed into the memory cell array 1211.

As described with reference to FIGS. 1 and 2, the flash memory system 1000 in FIG. 1 includes the program fail memory 1222 to re-perform a program operation using the data stored in the program fail memory 1222 when an error occurs during the program operation. Accordingly, the flash memory system 1000 in FIG. 1 may stably program write-requested data into the flash storage device 1200 from the host 1100.

The flash memory system 1000 in FIG. 1 requires a high-capacity volatile memory to be used as the program fail memory 1222. For example, in the case where a data storage capacity of a single page is 8 kilobytes (KB), the flash storage device 1200 in FIG. 2 requires a volatile memory of at least 32 kilobytes. If the flash memory device 1200 includes four flash memories, the flash storage device 1200 requires a volatile memory of at least 128 kilobytes.

Such a requirement of a high-capacity volatile memory serves to an obstacle to miniaturization of flash memory devices. Hereinafter, there will be described another exemplary embodiment which is capable of stably programming write-requested data from a host without including a program fail memory.

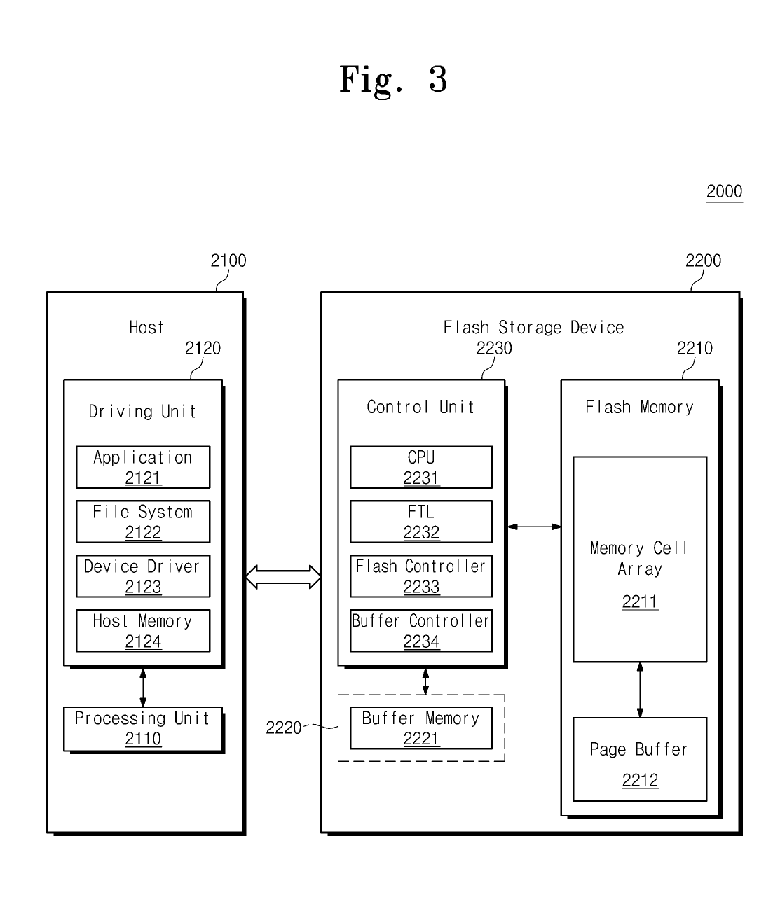

FIG. 3 is a block diagram of a flash memory system 2000 according to another exemplary embodiment. The flash memory system 2000 in FIG. 3 has a similar configuration to the flash memory system 1000 in FIG. 1. Therefore, similar elements will be explained with similar reference numerals. Hereinafter, differences between the flash memory system 2000 in FIG. 3 and the flash memory system 1000 in FIG. 1 will now be explained. Referring to FIG. 3, the flash memory system 2000 includes a host 2100 and a flash storage device 2200.

Unlike the flash memory device 1200 in FIG. 1, the flash storage device 2200 in FIG. 3 does not include a program fail memory (1222 in FIG. 1). That is, as shown in FIG. 3, a predetermined area of a working memory 2220 is allocated to a buffer memory 2221 but not allocated to a program fail memory.

The flash storage device 2200 in FIG. 3 does not include a program fail memory and uses a host memory 2124 as a program backup memory. That is, when an error occurs during a program operation, the flash storage device 2200 in FIG. 3 re-receives data stored in the host memory 2124 and reprograms data transferred from the host memory 2124 into a memory cell array 2211.

Thus, the flash storage device 2200 in FIG. 3 may program write-requested data from a host into the memory cell array 2211. In addition, since the flash storage device 2200 in FIG. 3 does not include a program fail memory, it may be implemented in a small area.

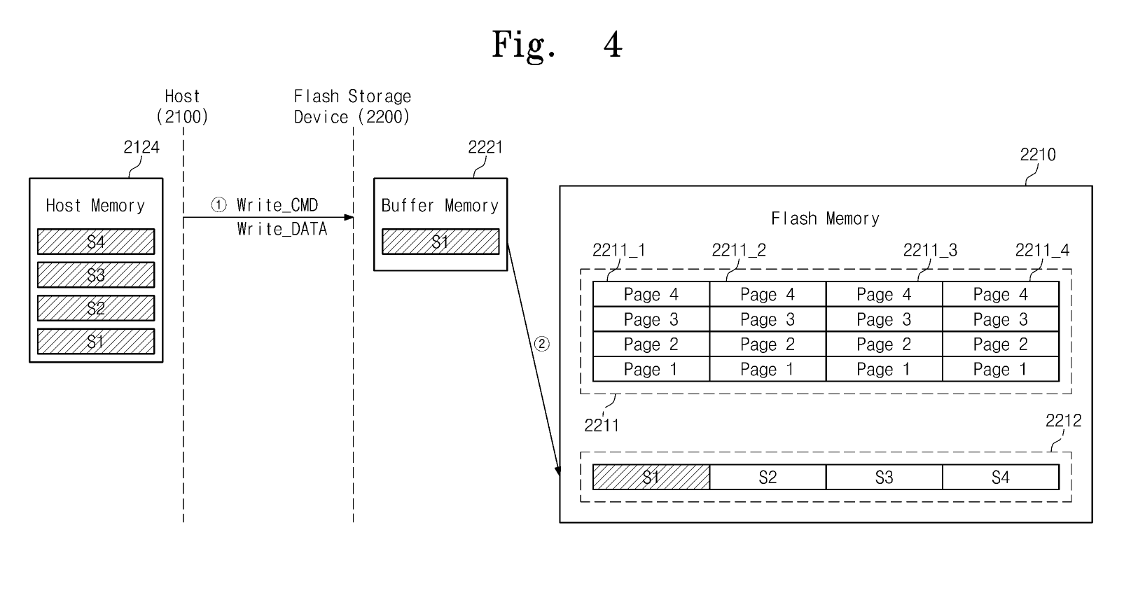

The flash storage device 2200 transfers two response signals for one write command from the host 2100 to the host 2100 to use the host memory 2124 as a program backup memory. In this case, one of the response signals includes information on whether the data is successfully transferred to the flash storage device 2200 from the host 2100. The other response signal includes information on whether a program operation into the memory cell array 2211 is successfully performed. This will be described below in further detail with reference to FIGS. 4 to 6.

FIGS. 4 to 6 illustrate exemplary embodiments of the operation of the flash memory system 2000 in FIG. 3 when there is write request from the host 2100.

FIGS. 4 to 6, similar to FIG. 2, illustrates an exemplary embodiment where a file management unit for the host 2100 matches a page unit which is a data management unit for the flash storage device 2200. In addition, a buffer memory 2221 has a size to store only data equivalent to a single page (or a single sector). In addition, the page buffer 2212 has a size to store data equivalent to four pages and the four pages are programmed at one time. Finally, a memory cell array 2211 includes first to fourth memory blocks 2211_1-2211_4 each including four pages. Again, however, one of ordinary skill in the art will recognize that the sector unit, page unit, buffer memory, page buffer, and memory cell array may vary.

FIGS. 4 to 6 illustrate an exemplarily embodiment wherein data stored in first to fourth sectors S1-S4 of a host memory 2124 are programmed into a flash memory 2210. For the brevity of description, a sector or page storing data will be shown with oblique lines hereinafter.

Referring to FIG. 4, data is stored in the first to fourth sectors S1-S4 of the host memory 2124. The host 2100 transfers a write command Write_CMD and write data Write_DATA to the flash storage device 2200 to store the data stored in the first to fourth sectors S1-S4 of the host memory 2124 in the flash memory 2210. The write data Write_DATA means the data stored in the first to fourth sectors S1-S4 of the host memory 2124. The data stored in the first to fourth sectors S1-S4 are sequentially transferred to the flash storage device 2200.

The buffer memory 2221 receives the write data Write DATA from the host 1100. Since the buffer memory 2211 has a size to temporarily store only data equivalent to a single sector, the buffer memory 2221 receives the data of the first sector S1 of the host memory 2124 and temporarily stores the received data. The data stored in the buffer memory 2221 is then transferred to the page buffer 2212 of the flash memory 2210. The data stored in the buffer memory 2221 is then erased in response to the control of a buffer controller 2234 and the buffer memory 2221 enters a free state.

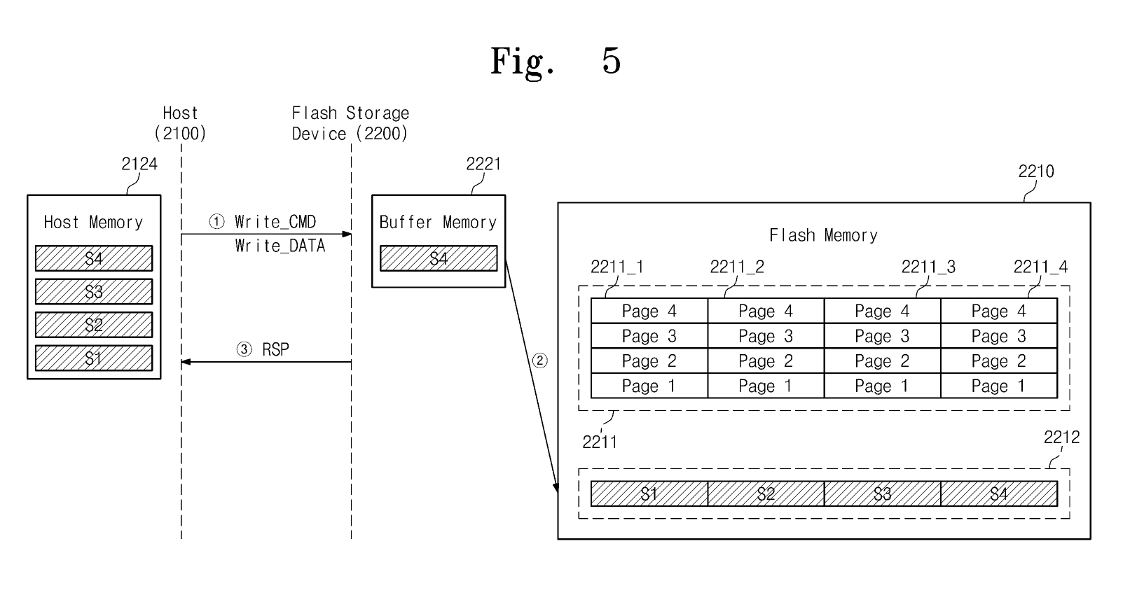

Referring to FIG. 5, the data of the second to fourth sectors S2-S4 are sequentially stored in the page buffer 2212 through the buffer memory 2221. After the data of the fourth sector S4 is transferred to the page buffer 2212, the data stored in the buffer memory 2221 is erased. That is, the buffer memory 2221 is converted into a free state.

If the write data Write_DATA is transferred to the flash storage device 2200, the flash storage device 2200 transfers a first response signal RSP_1 to the host 2100. As an example, the flash storage device 2200 may issue the first response signal RSP_1 when the write data Write_DATA is transferred to the page buffer 2212. Alternatively, the flash storage device 2200 may issue the first response signal RSP_1 when the write data Write DATA is transferred to the buffer memory 2221 (i.e., when the data of the fourth sector S4 is transferred to the buffer memory 2221).

The first response signal RSP_1 includes information on whether write data is successfully transferred to the flash storage device 2200 from the host 2100. For example, when an error occurs while the write data Write_DATA is transferred to the flash storage device 2200 from the host 2100, the host 2100 re-transfers the write data Write DATA to the flash storage device 2200 in response to the first response signal RSP_1. In this case, the write data Write_DATA is re-transferred to the page buffer 2212 through the buffer memory 2221.

If the write data Write_DATA is successfully transferred to the flash storage device 2200 from the host 2100, the host 2100 may issue a new command (e.g., write, read, and erase operation). This is because the write data Write_DATA is successfully transferred to the flash storage device 2200 from the host 2100 and the buffer memory 2221 of the flash storage device 2220 is in a free state where new data may be stored. Accordingly, in this case, the host 2100 is converted into a state where a new command (e.g., write, read, and erase operations) may be issued in response to the first response signal RSP_1. Note that, in this case, the write data Write_DATA stored in the host memory 2124 is not erased and is maintained.

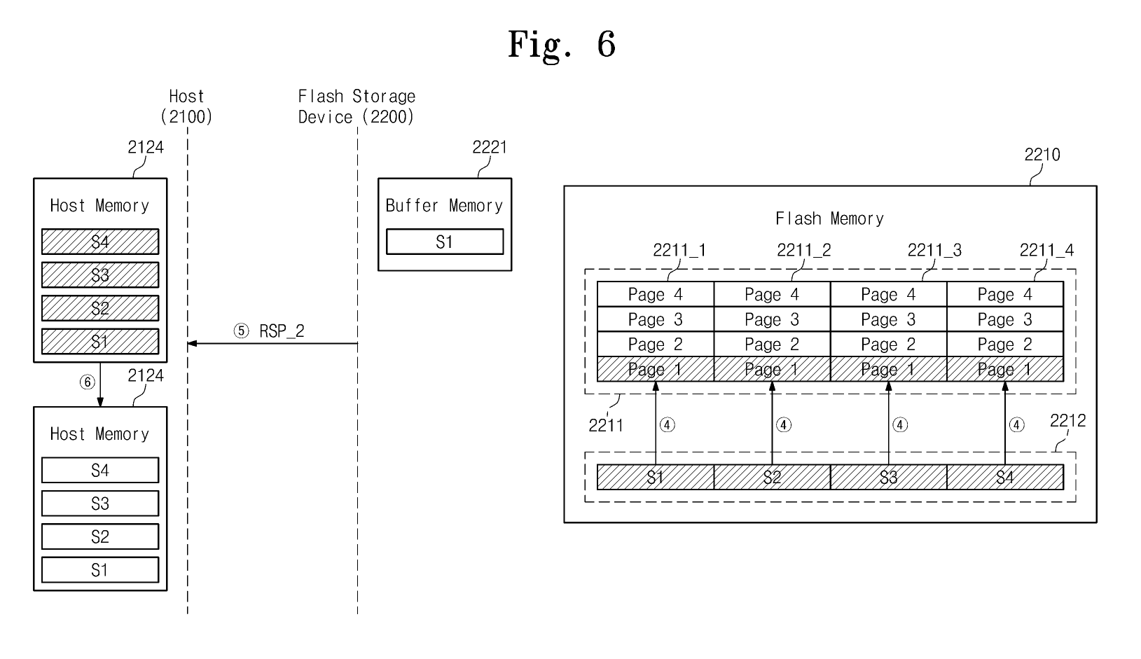

Referring to FIG. 6, the data stored in the page buffer 2212 is programmed into the memory cell array 2211. For example, as shown in FIG. 6, the data of the first to fourth sectors S1-S4 stored in the page buffer 2212 are programmed at one time into first pages of first to fourth memory blocks 2211_1-2211_4.

When programming the data stored in the page buffer 2212 into the memory cell array 2211 is terminated, the flash storage device 2200 transfers a second response RSP_2 to the host 2100. The second response signal RSP_2 includes information on whether the program operation to the memory cell array 2211 from the page buffer 2212 is successfully performed.

When the data stored in the page buffer 2212 is successfully programmed into the memory cell array 2211, the host 2100 erases the data of the first to fourth sectors S1-S4 stored in the host memory 2124 in response to the second response signal RSP_2. That is, the host memory 2124 enters a free state.

If an error occurs while the data stored in the page buffer 2212 is programmed into the memory cell array 2211, the host 2100 re-transfers the data of the first to fourth sectors S1-S4 of the host memory 2124 to the flash storage device 2200 in response to the second response signal RSP_2. In this case, the data of the first to fourth sectors S1-S4 of the host memory 2124 are stored in the page buffer 2212 through the buffer memory 2221. The data stored in the page buffer 2212 is re-programmed into the memory cell array 2211.

As described with reference to FIGS. 3 to 6, the flash storage device 2200 in FIG. 3 does not include a program fail memory. Therefore, the flash storage device 2200 in FIG. 3 may be implemented with a smaller size than the flash storage device 1200 in FIG. 1. In addition, the flash storage device 2200 in FIG. 3 provides first and second response signals to the host 2100 in response one write command. Thus, the flash storage device 2200 in FIG. 3 may use the host memory 2124 of the host 2100 as a program backup memory. As a result, the flash storage device 2200 in FIG. 3 may stably perform a program operation.

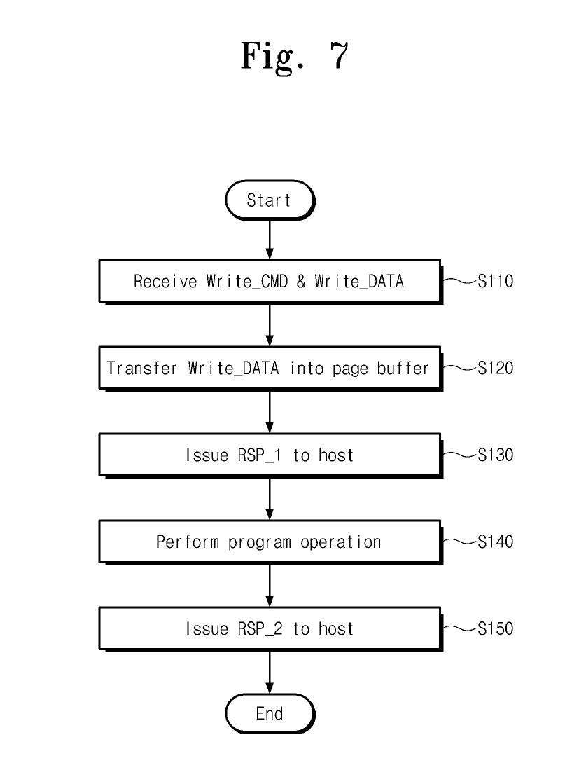

FIG. 7 is a flowchart illustrating the operation of the flash memory device 2200 in the flash memory system 2000 in FIG. 3. In FIG. 7, the operation of the flash storage device 2200 when there is a write request will now be described below.

At step S110, a write command Write_CMD and write data Write_DATA are transferred to the flash storage device 2200 from the host 2100. That is, the processing unit 2110 of the host 2100 transfers the write command Write_CMD to the flash storage device 2200. In this case, the write data Write DATA stored in the host memory 2124 of the host 2100 is also transferred to the flash storage device 220.

At step S120, the write data Write_DATA is transferred to the page buffer 2212 of the flash storage device 2200. That is, the write data Write_DATA transferred from the host 2100 is sequentially stored in the page buffer 2212 through the buffer memory 2221.

At step S130, the flash storage device 2200 issues a first response signal RSP_1. That is, the flash storage device 2200 transfers the first response signal, which includes information on whether the data is successfully transferred to the flash storage device 2200 from the host 2100, to the host 2100.

If an error occurs while the data is transferred to the flash storage device 2200 from the host 2100, the flash storage device 2200 issues a first response signal RSP_1 including information indicating that a data transfer error occurs. In this case, the flash storage device 2200 re-receives the write data Write DATA from the host 2100.

If the data is successfully transferred to the flash storage device 2200 from the host 2100, the flash storage device 2200 issues a first response signal RSP_1 including information indicating that the data is successfully transferred.

At step S140, a program operation is performed. That is, when the write data Write_DATA is successfully transferred to the page buffer 2212, the data stored in the page buffer 2212 is programmed into the memory cell array 2211.

At step S150, the flash storage device 2200 issues a second response signal RSP_2. That is, the flash storage device transfers the second response signal RSP_2, which includes information on whether a program operation to the memory cell array 2211 is successfully performed, to the host 2100.

If an error occurs during the program operation, the flash storage device 2200 issues a second response signal RSP_2 including information indicating that an error occurs during a program operation. In this case, the flash storage device 2200 re-receives the write data Write_DATA from the host 2100 and re-performs the program operation.

If the program operation is successfully performed, the flash storage device 2200 issues a second response signal RSP_2 including information indicating that a program operation is successfully performed.

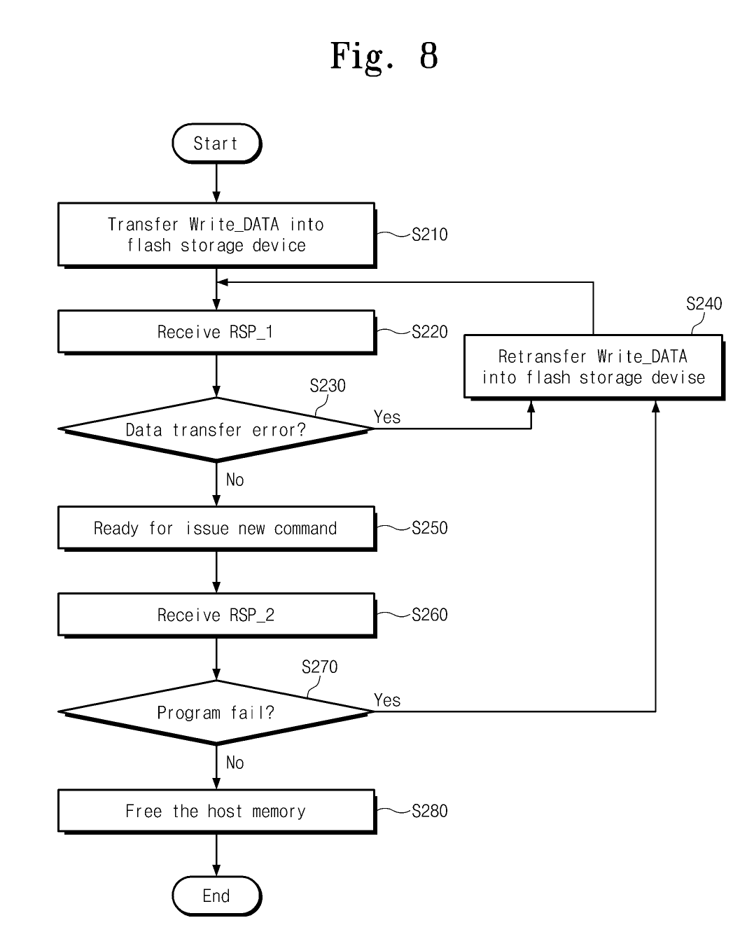

FIG. 8 is a flowchart illustrating the operation of the host 2100 in the flash memory system 2000 in FIG. 3. In FIG. 8, the operation of the host 2100 when there is a write request will now be described below.

At step S210, the host 2100 transfers a write command Write_CMD and write data Write_DATA to the flash storage device 2200.

At step S220, the host 2100 receives a first response signal RSP_1 from the flash storage device 2200.

At step S230, the host 2100 determines whether a data transfer error occurs. That is, based on the first response signal RSP_1, the host 2100 determines whether an error occurs while data is transferred to the flash storage device 2200 from the host 2100.

When the data transfer error occurs, the host 2100 re-transfers the write data Write_DATA to the flash storage device 2200 (step S240). When the data transfer error does not occur, the host 2100 enters a state to issues a new command (step S250). That is, when the data transfer error does not occur, the host 2100 enters a ready state to request the flash storage device 2200 to perform a new operation.

At step S250, the host 2100 receives a second response signal RSP_2 from the flash storage device 2200. That is, based on the second response signal RSP_2, the host 2100 determines whether an error occurs while the write data Write_DATA is programmed into the memory cell array 2210.

When a program failure occurs, the host 2100 re-transfers the write data Write_DATA to the flash storage device 2200 (step S240). When a program failure does not occur, the host 2100 erases the data stored in the host memory 2124. That is, the host memory 2124 enters a free state.

As described with reference to FIGS. 7 and 8, the flash storage device 2200 re-performs a program operation using the data stored in the host memory 2124 of the host 2100 when a program failure occurs. For the purpose of achieving this, the data stored in the host memory 2124 of the host 2100 is maintained until the program operation of the flash storage device 2210 is terminated. That is, the flash storage device 2200 uses the host memory 2124 of the host 2100 as a program backup memory to be implemented in a small area and stably perform a program operation.

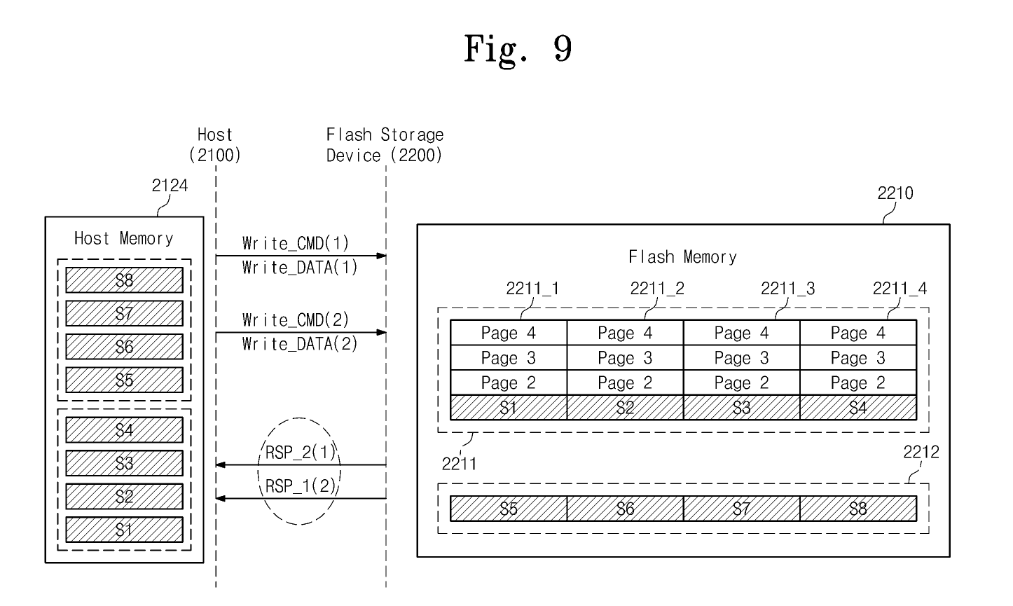

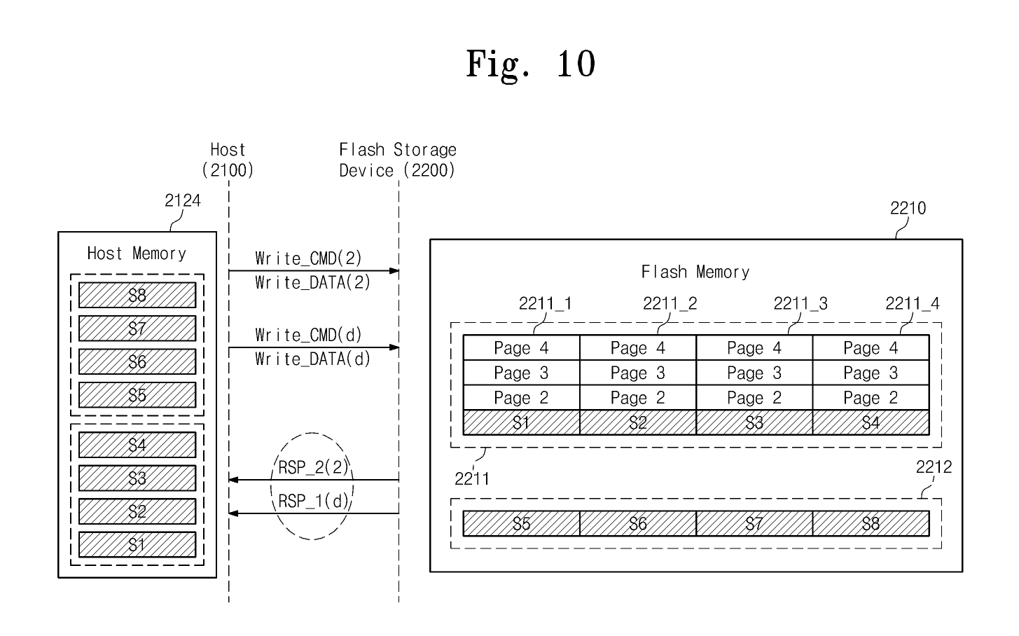

When there are a plurality of write commands to the flash storage device 2200 from the host 2100, the first response signal RSP_1 and the second response signal RSP_2 issued from the flash storage device 2200 may be simultaneously transferred to the host 2100. That is, the second response signal RSP_2 issued in response to a previous write command and the first response signal RSP_1 issued in response to a current write command may be transferred to the host 2100 as a single packet. This will be described below in further detail with reference to FIGS. 9 and 10.

FIGS. 9 and 10 illustrate an exemplary embodiment of the operation of the flash memory system 2000 in FIG. 3 when there are a plurality of write commands. In FIGS. 9 and 10, for example, a first write command Write_CMD(1) and first write data Write_DATA(1) are transferred to the flash storage device 2200 from the host 2100 and a second write command Write_CMD(2) and second write data Write_DATA(2) are then transferred to the flash storage device 2200 from the host 2100.

Referring to FIG. 9, the host 2100 transfers the first write command Write_CMD(1) and the first write data Write_DATA(1) to the flash storage device 2200. For example, the first write data Write_DATA(1) may be data stored in the first to fourth sectors S1-S4 of the host memory 2124. In this case, the host 2100 transfers the data of the first to fourth sectors S1-S4 of the host memory 2124 to the flash storage device 2200. The flash storage device 2200 programs the data of the first to fourth sectors S1-S4 into the memory cell array 2211, as shown in FIG. 9. After the program operation is terminated, the data stored in the page buffer 2212 is erased.

And then, the host 2100 transfers the second write command Write_CMD(2) and the second write data Write_DATA(2) to the flash storage device 2200. For example, the second write data Write_DATA(2) may be data stored in fifth to eighth sectors S5-S8 of the host memory 2124. In this case, the host 2100 transfers the data of the fifth to eighth sectors S5-S8 of the host memory 2124 to the flash storage device 2200. The flash storage device 2200 stores the data of the fifth to eighth sectors S5-S8 to the page buffer 2212, as shown in FIG. 9.

In this case, the flash storage device 2200 may simultaneously transfer a second response signal RSP_2(1) including information on whether the first write data Write_DATA(1) is program-failed and a first response signal RSP_1(2) including information on whether the second write data Write_DATA(2) is successfully transferred.

That is, the flash storage device 2200 may transfer an (n-1)th second response signal for an (n-1)th write command and (n-1)th write data and an nth first response signal for an nth write command and nth write data to the host 2100 as a single packet. Thus, the overhead consumed for transferring a response signal to the host 2100 from the flash storage device 2200 may be reduced.

If the nth write command is not transferred to the flash storage device 2200 from the host 2100 when a second response signal and a first response signal are transferred as a single packet, the (n-1)th second response signal may not be transferred to the host 2100 from the flash storage device 2200. In order to avoid this danger, the host 2100 may transfer a dummy write command to the flash storage device 220 when there is no write command for a predetermined time.

For example, referring to FIG. 10, let it be assumed that there is no new write request for a predetermined time after transferring the second write command Write_CMD(2) to the flash storage device 2200 from the host 2100. In this case, a second response signal RSP_2(2) for the second write command Write_CMD(2) may not be transferred to the host 2100.

In order to overcome the above problem, the host 2100 transfers a dummy write command Write_CMD(d) and dummy write data Write_DATA(d) to the flash storage device 2200. In this case, with the first response signal RSP_1(d) for the second write command Write_CMD(2), the second response signal RSP_2(2) for the second write command

Write_CMD(2) may be transferred to the host 2100 from the flash storage device 2200.

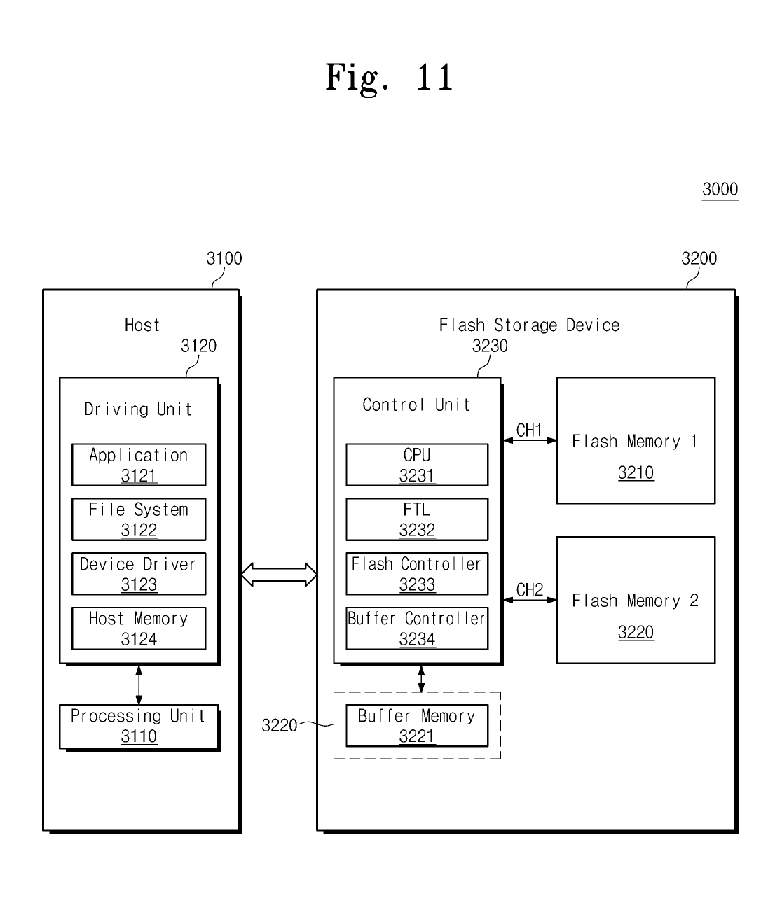

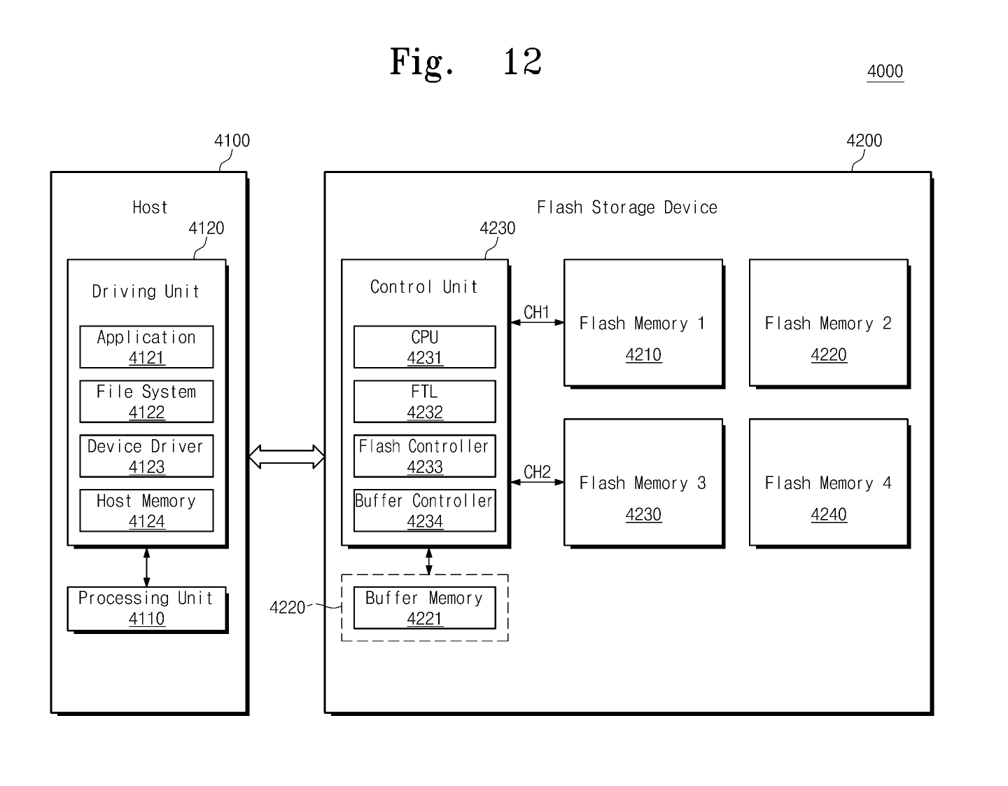

The flash storage device described with reference to FIGS. 3 to 9 includes one flash memory. However, it will be understood that this description is merely an exemplary embodiment and the disclosure is not limited thereto. For example, a flash storage device according to an exemplary embodiment may include a plurality of flash memories. Hereinafter, an exemplary embodiment of a flash storage device including a plurality of flash memories will be described below with reference to FIGS. 11 and 12.

FIG. 11 is a block diagram of a flash memory system 3000 according to an exemplary embodiment. The configuration of the flash memory system 3000 in FIG. 11 is similar to that of the flash memory system 2000 in FIG. 3. Therefore, similar elements will be explained with similar reference numerals. Hereinafter, differences between the flash memory system 3000 in FIG. 11 and the flash memory system 2000 in FIG. 3 will be explained.

Referring to FIG. 11, a flash storage device 3200 includes a plurality of flash memories. In FIG. 11, for example, the flash storage device 3200 includes two flash memories 3210 and 3220. A first flash memory 3210 is connected to a control unit 3230 through a first channel CH1, and a second flash memory 3220 is connected to the control unit 3230 through a second channel CH2.

Since the first flash memory 3210 and the second flash memory 3220 are connected in parallel to the control logic 3230 through the first channel CH1 and the second channel CH2, the control unit 3230 may individually control the first flash memory 3210 and the second flash memory 3220.

That is, the control unit 3230 may control the flash storage device 3200 to program write data into the first flash memory 3210. In this case, the host memory may be used as a program backup memory for a program operation into the first flash memory 3210. Similarly, the control unit 3230 may control the flash storage device 3200 to program write data into the second flash memory 3220. In this case, the host memory 3214 may be used as a program backup memory for a program operation into the second flash memory 3220.

The control unit 3230 may control the flash storage device 3200 to simultaneously program write data into the first flash memory 3210 and the second flash memory 3220. In this case, the host memory 3214 may be used as a program backup memory for a program operation into the first flash memory 3210 and the second flash memory 3220.

FIG. 12 is a block diagram of a flash memory system 4000 according to an exemplary embodiment. The configuration of the flash memory system 4000 in FIG. 12 is similar to that of the flash memory system 2000 in FIG. 3. Therefore, similar elements will be explained with similar reference numerals. Hereinafter, differences between the flash memory system 4000 in FIG. 12 and the flash memory system 2000 in FIG. 3 will be explained.

Referring to FIG. 12, a flash storage device 4200 includes a plurality of flash memories. In FIG. 12, for example, the flash storage device 4200 includes four flash memories 4210, 4220, 4230, and 4240. First and second flash memories 4210 and 4220 are connected to a control unit 4230 through a first channel CH1, and third and fourth flash memories 4230 and 4240 are connected to the control unit 4230 through a second channel CH2.

Since the first and second flash memories 4210 and 4220 share the first channel CH1, the control unit 4230 simultaneously programs write data into the first and second flash memories 4210 and 4220. In this case, a host memory 4124 may be used as a program backup memory for a program operation into the first and second flash memories 4210 and 4220.

Similarly, since the third and fourth flash memories 4230 and 4240 share the second channel CH2, the control unit 4230 simultaneously programs write data into the third and fourth flash memories 4230 and 4240. In this case, the host memory 4214 may be used as a program backup memory for a program operation into the third and fourth flash memories 4230 and 4240.

The control unit 4230 may control the flash storage device 3200 to simultaneously program write data into the first to fourth flash memories 4210-4240. In this case, the host memory 4214 may be used as a program backup memory for a program operation into the first to fourth flash memories 4210-4240.

As described with reference to FIGS. 11 and 12, technical ideas of the disclosure may be applied to a flash storage device including a plurality of flash memories. Thus, the flash storage device including a plurality of flash memories uses a host memory of a host as a program backup memory to be implemented in a small area and stably perform a program operation.

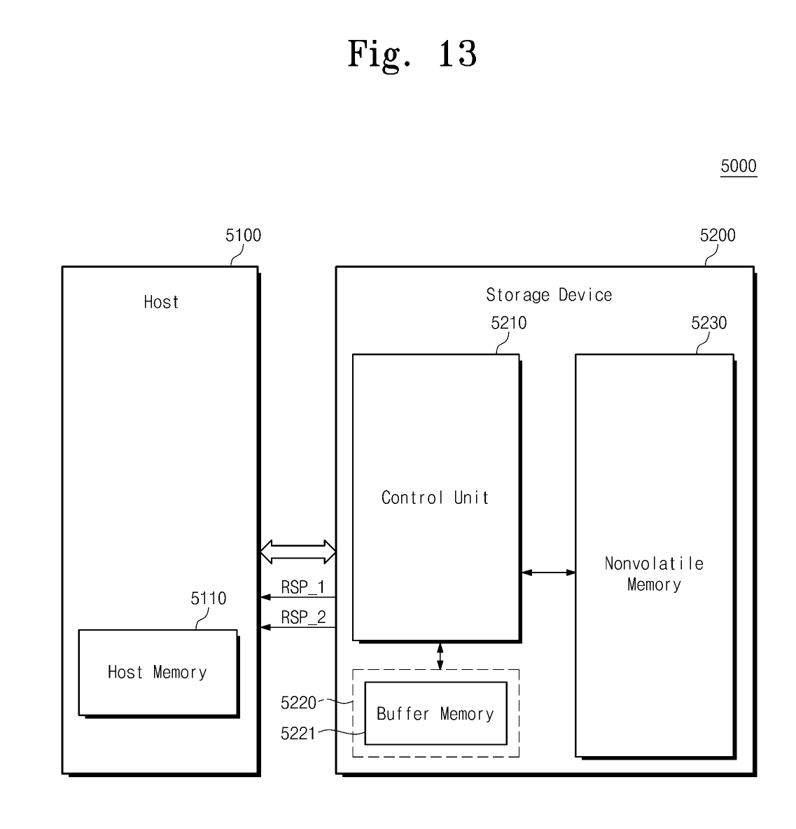

In FIGS. 3 to 12, it has been described that technical ideas of the disclosure may be applied to a flash storage device. However, it will be understood that the description is merely exemplary and the embodiments of the disclosure are not limited thereto. For example, the technical ideas of the disclosure may be applied to any storage device including, but not limited to, a nonvolatile memory such as a PRAM, an MRAM, and an RRAM. This will be described below in further detail with reference to FIG. 13.

FIG. 13 is a block diagram of a memory system 5000 according to an exemplary embodiment of the inventive concept. Referring to FIG. 13, the memory system 5000 includes a host 5100 and a storage device 5200.

The storage device 5200 in FIG. 13 includes a nonvolatile memory 5230 as a storage device configured to store data. The nonvolatile memory 5230 may be implemented as not only a flash memory but also a PRAM, an RRAM, an MRAM, an FRAM, etc.

When there is a write command from the host 5100, the storage device 5200 programs the write data into the nonvolatile memory 5230. In this case, the storage device 5200 may use the host memory 5110 of the host 5100 as a backup memory of the write data. The storage device 5200 transfers two response signals RSP_1 and RSP_2 to the host 5100 in response to one write command to use the host memory 5110 as a backup memory.

Similar to the flash storage device described with reference to FIGS. 3 to 12, the first response signal RSP_1 includes information on whether data is successfully transferred to the storage device 5200 from the host 5100, and the second response signal RSP_2 includes information on whether a program operation into the nonvolatile memory 5230 is successfully performed. The storage device 5200 uses the host memory 5100 of the host 5100 as a program backup memory to be implemented in a small area and stably perform a program operation.

The memory system according to the exemplary embodiments described with reference to FIGS. 3 to 12 may be applied to computers, digital cameras, cell phones, MP3 players, portable multimedia players (PMPs), game players, etc. The flash storage device 1200 may be incorporated into a solid-state drive (SSD), a flash memory card, a flash memory module that is based on a flash memory, etc. A host and a flash storage device may be connected to each other through a standardized interface such as ATA, SATA, PATA, USB, SCSI, ESDI, PCI express, IDE interface, etc.

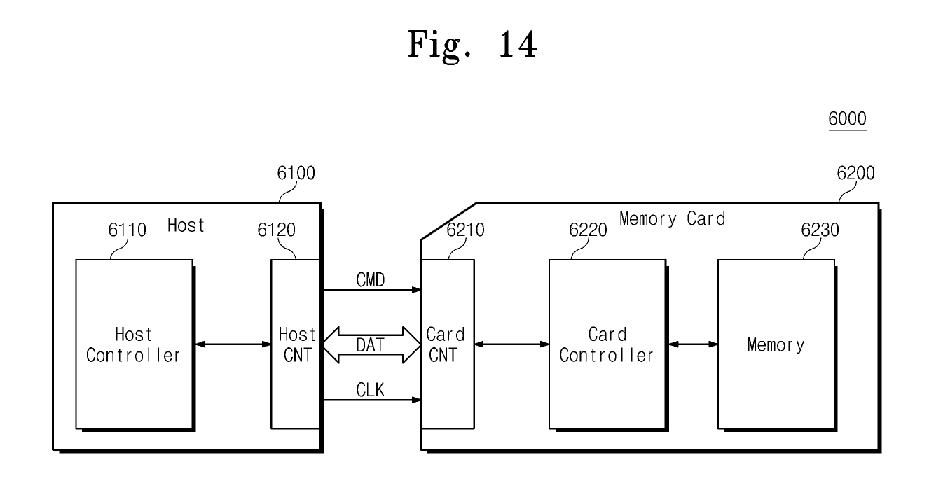

FIG. 14 illustrates a memory card according to an exemplary embodiment. A memory card system 6000 includes a host 6100 and a memory card 6200. The host 6100 includes a host controller 6110 and a host connection unit 6120. The memory card 6200 includes a card connection unit 6210, a card controller 6220, and a flash memory 6230.

The host connection unit 6120 and the card connection unit 6210 are configured with a plurality of pins. The pins include a command pin, a data pin, a clock pin, a power supply pin, etc. The number of pins varies with the kind of the memory card 6200. For example, an SD card includes nine pins.

The host 6100 writes data in the memory card 6200 or reads data stored in the memory card 6200. The host controller 6110 transfers a command (e.g., a write command), a clock signal CLK generated by a clock generator (not shown) in the host 6100, and data DAT to the memory card 6200 through the host connection unit 6120.

The card controller 6220 stores data in the memory 6260 in synchronization with a clock signal generated by a clock generator (not shown) in the card controller 6220 in response to the write command received through the card connection unit 6210. The memory 6230 stores data transferred from the host 6100. For example, when the host 6100 is a digital camera, the memory 6230 stores image data.

In FIG. 14, the host 6100 includes a host memory, and the host controller 6110 and the card controller 6220 may control the host 6100 and the memory card 6200 such that a host memory is used as a program backup memory.

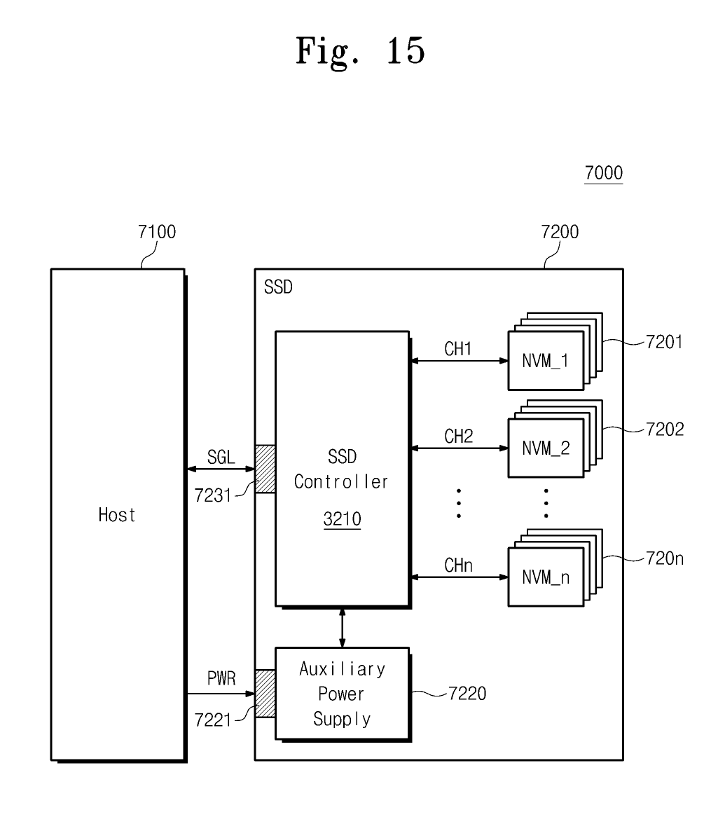

FIG. 15 illustrates a solid-state drive (SSD) according to an embodiment. Referring to FIG. 15, an SSD system 7000 includes a host 7100 and an SSD 7200. The SSD 7200 transfers/receives a signal to/from the host 7100 through a signal connector 7231 and receives a power supply through a power connector 7221. The SSD 7200 includes a plurality of nonvolatile memory devices 7201-720n, an SSD controller 7210, and an auxiliary power supply 7220.

The nonvolatile memory devices 7201-720n are used as storage media of the SSD 7200. The nonvolatile memory devices 7201-720n may be implemented as flash memory devices with high-capacity storage capability.

The nonvolatile memory devices 7201-720n may be connected to the SSD controller 7210 through a plurality of channels CH1-CHn. One or more memory devices may be connected to one channel. Memory devices connected to one channel may be connected to the same data bus. Flash defragmentation may be performed in the form of a superblock in which a plurality of blocks are combined or a superpage in which a plurality of pages are combined.

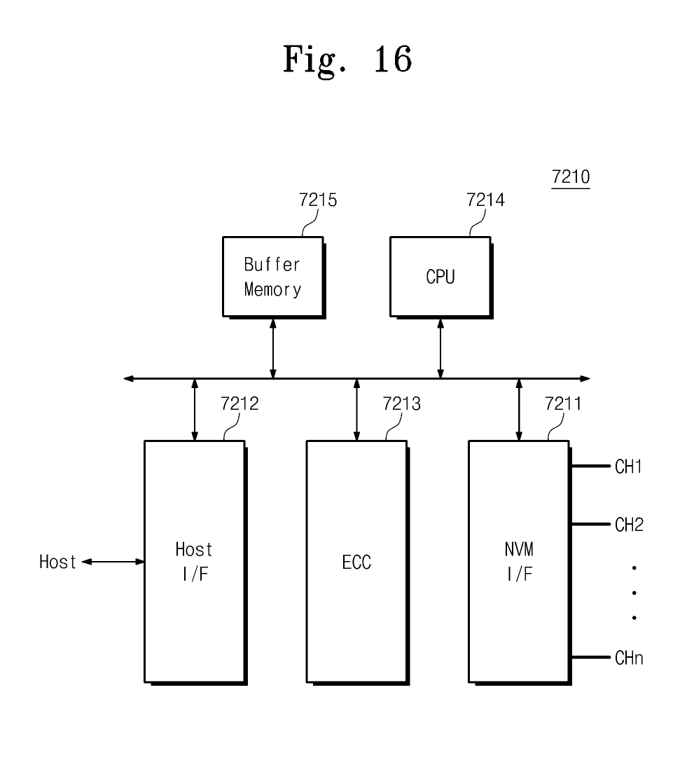

The SSD controller 7210 transfers/receives a signal SGL to/from the host 7100 through the signal connector 7231. The signal may include a command, an address, data, etc. According to the command of the host 7100, the SSD controller 7210 writes data into a corresponding memory device or reads data from the corresponding memory device. The internal configuration of the SSD controller 7210 will be described in detail later with reference to FIG. 16.

The auxiliary power supply 7220 is connected to the host 7100 through a power connector 7221. The auxiliary power supply 7220 receives a power source PWR from the host 7100. The auxiliary power supply 7220 may be disposed inside or outside the SSD 7200. For example, the auxiliary power supply 7220 may be disposed at a main board and supply an auxiliary power source to the SSD 7200.

FIG. 16 is a block diagram illustrating an exemplary configuration of the SSD controller 7210 shown in FIG. 15. Referring to FIG. 16, the SSD controller 7210 includes an NVM interface 7211, a host interface 7212, an ECC 7213, a central processing unit (CPU) 7214, and a buffer memory 7215.

The NVM interface 7211 scatters data transferred from the buffer memory 7215 to respective channels CH1-CHn. The NVM interface 7211 transfers data read from the nonvolatile memory device 7201-720n to the buffer memory 7215. The NVM interface 7211 may adopt an interface scheme of a NAND flash memory. That is, the SSD controller 7210 may perform a program, read or erase operation according to the interface scheme of the NAND flash memory.

The host interface 7212 provides an interface with the SSD 7200 in response to the protocol of the host 7100. The host interface 7212 may communicate with the host 7100 via USB (Universal Serial Bus), SCSI (Small Computer System Interface), PCI express, ATA, PATA (Parallel ATA), SATA (Serial ATA), SAS (Serial Attached SCSI), etc. Moreover, the host interface 7212 may perform a disk emulation function of supporting a function that allows the host to recognize the SSD 7200 as a hard disk drive (HDD).

The CPU 7214 analyzes and processes a signal SGL input from the host (7100 in FIG. 16). The CPU 7214 controls the host or the nonvolatile memory devices 7201-720n through the host interface 7212 or the NVM interface 7211. The CPU 7214 controls the operations of the nonvolatile memory devices 7201-720n according to firmware for driving the SSD 7200.

The buffer memory 7215 temporarily stores writing data provided from the host 7100 or data read from the nonvolatile memory device. Moreover, the buffer memory 7215 may store meta data or cache data to be stored in the nonvolatile memory devices 7201-720n. In a sudden power-off operation, the meta data or cache data stored in the buffer memory 7215 is stored in the nonvolatile memory devices 7201-720n. The buffer memory 7215 may include a DRAM and an SRAM.

The flash memory system or the memory system described in FIGS. 3 to 13 may be applied to the solid-state drive 7000 illustrated in FIGS. 15 and 16.

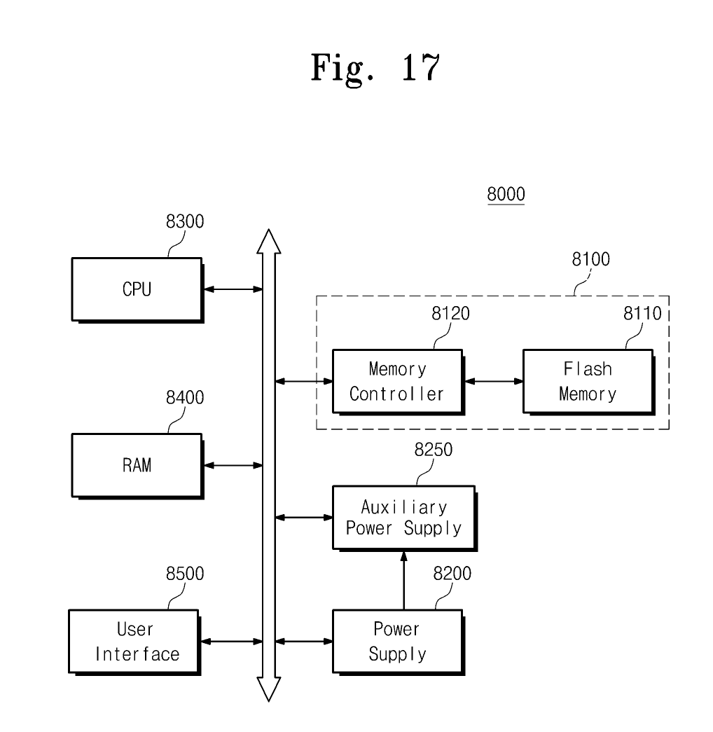

FIG. 17 is a block diagram illustrating a flash memory module 8000 implemented with a host according to an exemplary embodiment. A host such as a personal computer (PC), a notebook computer, a cell phone, a personal digital assistant (PDA), a digital camera, etc. may be used by connecting to the flash memory module 8000.

Referring to FIG. 17, the flash memory module 8000 includes a memory system 8100, a power supply 8200, an auxiliary power supply 8250, a central processing unit (CPU) 8300, and a user interface 8500. A flash memory system described with FIGS. 3 to 13 may be applied to the flash memory module 8000 illustrated in FIG. 17.

While the disclosure has been particularly shown and described with reference to exemplary embodiments thereof, it will be apparent to those of ordinary skill in the art that various changes in form and detail may be made therein without departing from the spirit and scope of the disclosure as recited by the following claims.

What is claimed is:

1. A storage device, comprising:
a nonvolatile memory; and
a control unit configured to control the nonvolatile memory,
wherein the control unit outputs a first response signal comprising information indicating whether a first write data is successfully received from a host, and
wherein the control unit outputs a second response signal comprising information indicating whether the first write data is successfully stored in the nonvolatile memory.

2. The storage device of claim 1, wherein the first response signal and the second response signal are output in response to one write command from the host, and the control unit sequentially outputs the first response signal and the second response signal to the host.

3. The storage device of claim 1, further comprising:
a buffer memory which temporarily stores the first write data received from the host,
wherein the control unit outputs the first response signal in response to completion of the buffer memory receiving the first write data.

4. The storage device of claim 1, further comprising:
a buffer memory which temporarily stores the first write data received from the host; and
a page buffer which receives the first write data from the buffer memory and temporarily stores the first write data before the first write data is stored in the nonvolatile memory,
wherein the control unit outputs the first response signal in response to completion of the page buffer receiving the first write data.

5. The storage device of claim 1, wherein the control unit receives a first write command and the first write data from the host before receiving a second write command and second write data from the host,
wherein the control unit outputs a third response signal comprising information indicating whether the second write data is successfully received, and
wherein the control unit simultaneously outputs the third response signal and the second response signal.

6. The storage device of claim 5, wherein the control unit receives the second write command and the second write data from the host before receiving a dummy write command from the host,
wherein the control unit outputs a dummy response signal comprising information indicating whether the second write data is successfully stored in the nonvolatile memory, and
wherein the control unit simultaneously outputs the dummy response signal and the third response signal to the host.

7. The storage device of claim 1, wherein the control unit does not include a volatile memory for backing up the first write data while the first write data is stored in the nonvolatile memory.

8. A user device, comprising:
a processing unit which outputs a first write data to a storage device; and
a host memory which temporarily stores the first write data,
wherein the processing unit determines whether to re-transmit the first write data in response to a first response signal from the storage device, and
wherein the processing unit determines whether to re-transmit the first write data in response to a second response signal from the storage device,
wherein the processing unit determines whether to erase the first write data stored in the host memory in response to the second response signal from the storage device.

9. The user device of claim 8, wherein the first response signal comprises information indicating whether the first write data was successfully transferred to the storage device.

10. The user device of claim 9, wherein the processing unit re-transfers the first write data stored in the host memory to the storage device in response to the first response signal indicating that the first write data was not successfully transferred to the storage device.

11. The user device of claim 9, wherein the processing unit maintains the first write data stored in the host memory in response to the first response signal indicating the first write data was successfully transferred to the storage device.

12. The user device of claim 8, wherein the second response signal comprises information indicating whether the first write data was successfully stored in the storage device.

13. The user device of claim 12, wherein the processing unit re-transfers the first write data stored in the host memory in response to the second response signal indicating that the first write data was not successfully stored in the storage device.

14. The user device of claim 12, wherein the processing unit erases the first write data stored in the host memory in response to the second response signal indicating that the first write data was successfully stored in the storage device.

15. The user device of claim 12, wherein the processing unit outputs the first write data before outputting and a second write data to the storage device and simultaneously receives the second response signal and a third response signal, the third response signal including information indicating whether the second write data was successfully transferred to the storage device.

16. A storage device, comprising:
a nonvolatile memory; and
a control unit configured to output a first response signal in response to first write data received from a host and output a second response signal in response to the first write data being stored in the nonvolatile memory.

17. The storage device of claim 16, wherein the first response signal comprises information indicating whether the first write data is successfully received from the host.

18. The storage device of claim 16, wherein the second response signal comprises information indicating whether the first write data is successfully stored in the nonvolatile memory.

19. The storage device of claim 18, wherein the second response signal further comprises information indicating whether a second write data is successfully received from the host.

20. The storage device of claim 16, further comprising:
a buffer memory which temporarily stores the first write data received from the host; and
a page buffer which receives the first write data from the buffer memory and temporarily stores the first write data before the first write data is stored in the nonvolatile memory,
wherein the control unit outputs the first response signal in response to completion of the page buffer receiving the first write data.
